(19) United States
(12) Patent Application Publication
(10) Pub. No.: US 2008/0110937 A1
(43) Pub. Date: May 15, 2008

(54) SPRAY BOTTLE

(76) Inventor: Sidney Guill, Mattoon, IL (US)

Correspondence Address: MICHAEL BERNS;MALONEY, PARKINSON AND BERNS, 135 W MAIN STREET, URBANA, IL, 61801, US

(21) Appl. No.: 11/938,075

(22) Filed: Nov. 9, 2007

Related U.S. Application Data
(60) Provisional application No. 60/865,794, filed on Nov. 14, 2006.

(51) Int. Cl. B67D 5/60

(52) U.S. Cl. 222/464.4

(57) ABSTRACT

The present invention provides an improved spray bottle to allow the bottle to be turned sideways, even upside down, yet still allow spraying. A heavy bead is placed at the end of the intake tube to use gravity to keep it at the bottom of the liquid, even when the bottle is tilted. A flexible hose is used to allow movement of the intake tube to reach different areas of the bottle.

### CROSS-REFERENCE TO RELATED APPLICATION

This application claims the benefit of U.S. Provisional Application No. 60/865,794, filed Nov. 14, 2006, which is incorporated herein by reference.

### BACKGROUND OF THE INVENTION

When using a spray bottle for cleaners or other products, it is often necessary to tilt the bottle to spray in desired locations. When tipping a spray bottle that is not full, the end of the intake hose inside the bottle can make contact with the air inside the bottle, causing the bottle to spray air, instead of the liquid. This requires the user to re-prime the spray bottle to get the liquid going again to resume spraying.

Many patents have developed improved spray bottles that have attempted to solve this problem. The present invention solves the problem in an economical method that can be utilized, even in disposable bottles.

### SUMMARY OF THE INVENTION

The present invention provides an improved spray bottle to allow the bottle to be turned sideways, even upside down, yet still allow spraying. A heavy bead is placed at the end of the intake tube to use gravity to keep it at the bottom of the liquid, even when the bottle is tilted. A flexible hose is used to allow movement of the intake tube to reach different areas of the bottle.

### DESCRIPTION OF THE DRAWINGS

FIG. 1 is a side view of a spray bottle embodiment of the invention.

FIG. 2 is a side view of a spray bottle embodiment of the invention having a conical bottom on the bottle.

FIG. 3 is a side view of a spray bottle embodiment in an inverted position.

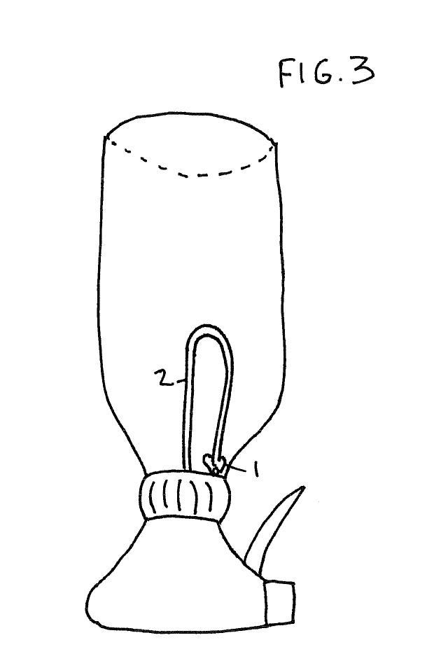

FIG. 4 is a detail view cross-section of an embodiment of the weighted tip.

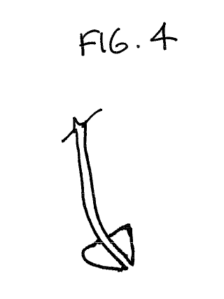

### DETAILED DESCRIPTION OF THE INVENTION

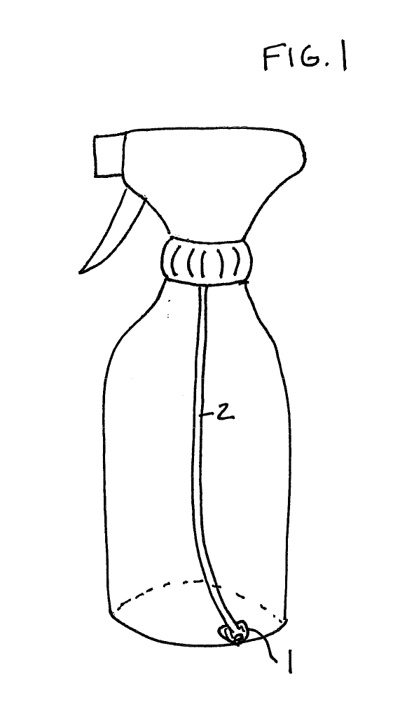

Referring to FIG. 1, a spray bottle is provided with a weighted bead 1 at the end of the liquid intake tube 2. The bead 1 may be metal or a dense material that allows it to sink to the bottom of the liquid. A prototype used a lead sinker bead, but other materials will be more suited to common applications. Zinc would be a more suitable materials that would be inexpensive and malleable to allow a good compression fitting with the intake tube.

A flexible plastic tube or hose2 that fits onto the inside top of a spray or pump bottle and extends to the center bottom and over to the farthest side, with a weighted bead on the end. No matter how you tilt the bottle use the spray or pump, the weight will pull the tube to the lowest point, ensuring the flow of liquid up the tube and out the spray or pump mechanism. The length and diameter of the tube and weight of the bead will be proportionate to the size of the bottle and include the height of the bottle, plus the radius to the farthest side of the bottle, which should accommodate both circular and non-circular bottles.

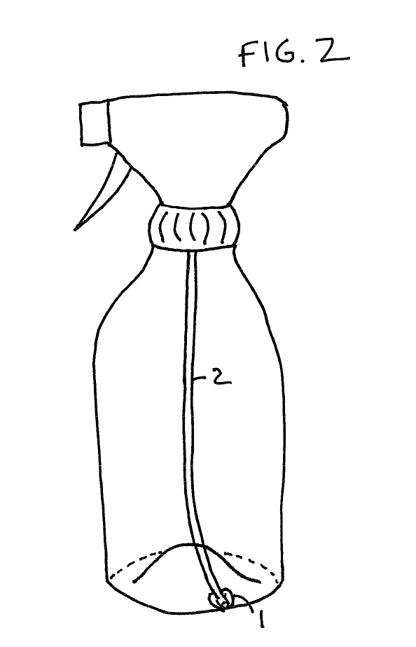

In another embodiment, the bottom of the spray bottle would be shaped to provide a channel that the end of the intake tube could rotate around in. This would allow the user to tip the spray bottle to a horizontal position in any direction and still allow the bead to travel along the channel to the lowest point to pick up the liquid. Tipping the spray bottle beyond horizontal would require the intake tube to be more flexible to turn back on itself and keep the intake end in the liquid. The bead 1 could be allowed to rotate, making movement of the bead 1 in the channel easier and smoother and prevent twisting of the intake tube. A raised, or conical section, as shown in FIG. 2, would create a channel that the bead 1 and end of the intake tube 2 would travel around.

It will be readily understood by those persons skilled in the art, that the present invention is susceptible to broad utility and application in spray bottles. Many embodiments and adaptations of the present invention, other than those described, as well as many variations, modifications, and equivalent arrangements, will be apparent from or reasonably suggested by the present invention and foregoing description thereof, without departing from the substance or scope of the invention.

While the foregoing description illustrates and describes exemplary embodiments of this invention, it is to be understood that the invention is not limited to the construction and design disclosed herein. The invention can be embodied in other specific forms without departing from the true invention.

I claim:

1. A spray bottle comprising:
a reservoir for holding a liquid,
a sprayer mechanism for pumping the liquid out a nozzle,
a flexible tube for intake of the liquid having a proximal end connected to the sprayer mechanism and a distal end for submersion into the liquid within the reservoir,
a weighted tip attached to distal end of the flexible tube, such that the weighted tip attaches to the flexible tube by a compression fit, and urges the distal end of the flexible tube to remain submerged within the liquid for pumping out of the sprayer mechanism.

2. The spray bottle according to claim 1, wherein the weighted tip is a metal material.

3. The spray bottle according to claim 2, wherein the weighted tip is covered in a plastic covering.

4. The spray bottle according to claim 1, wherein the reservoir includes a conical shaped bottom.
